(19) United States
(12) Patent Application Publication
(10) Pub. No.: US 2005/0127164 A1
(43) Pub. Date: Jun. 16, 2005

(54) Method and system for conducting a transaction using a proximity device and an identifier

(76) Inventor: John Wankmueller, Great Neck, NY (US)

Correspondence Address: BAKER & BOTTS, 30 ROCKEFELLER PLAZA, NEW YORK, NY, 10112, US

(21) Appl. No.: 10/876,872

(22) Filed: Jun. 25, 2004

Related U.S. Application Data
(63) Continuation-in-part of application No. PCT/US03/08377, filed on Mar. 19, 2003.
(60) Provisional application No. 60/482,564, filed on Jun. 25, 2003.
(60) Provisional application No. 60/365,737, filed on Mar. 19, 2002.

(51) Int. Cl. G06K 5/00

(52) U.S. Cl. 235/380

(57) ABSTRACT

A proximity device transmits a first dynamic authentication value contactlessly to a terminal. The first authentication value is included in a discretionary data field of message data arranged in an ISO Track 1 and/or ISO Track 2 format. Message data is sent from the terminal to an issuer. The issuer separately derives a second authentication value and compares it with the first authentication value. An identifier associated with the primary account number (PAN) is also used and transmitted instead of the PAN.

### PRIORITY AND RELATED APPLICATIONS

This application claims priority to U.S. provisional application 60/482,564 filed on Jun. 25, 2003, entitled “Method and System for Conducting a Transaction Using a Proximity Device,” which is hereby incorporated by reference in its entirety, and is a continuation-in-part of PCT application PCT/US 03/08377 filed on Mar. 19, 2003, entitled “Method and System for Conducting a Transaction Using a Proximity Device,” now published as WO 03/081832 A2 on Oct. 2, 2003, claiming priority to U.S. provisional application 60/365,737 filed on Mar. 19, 2002, all incorporated herein by reference in their entireties.

### BACKGROUND OF THE INVENTION

Magnetic stripe cards are often used today for conducting transactions such as debit and credit payments. Such payment cards store information in “tracks”—commonly denoted as “Track 1,” “Track 2,” and/or “Track 3”—on the magnetic stripe. When such payment cards are swiped through a card reader, data from the tracks is sent over a network to complete a transaction. Such cards frequently also include an authentication value printed on the card and an authentication value (which is usually different from the printed value) stored in the magnetic stripe, both of which help to protect against fraud. On a typical MasterCard™ card, the authentication values are called CVC1 (for the value stored in the magnetic stripe) and CVC2 (for the printed authentication value). The printed authentication value does not get transferred to carbon copy paper when a magnetic stripe card is run through an imprinter to make a mechanical copy of the card. Because of this, a duplicate of the card cannot readily be made from the account information transferred to a sales slip (i.e., account number, cardholder name, and expiration date). For telephone or internet purchases where a purchaser is not in the presence of a merchant, the printed value is especially useful to protect against fraud because only the person in possession of the card can verify the printed value to the merchant.

When a transaction involving a magnetic stripe card is conducted using a terminal, the terminal reads the information stored on at least one of the tracks of the credit card. Currently, most terminals read Track 1 and/or Track 2 of the magnetic stripe. The tracks are formatted according to standards promulgated by the International Organization for Standardization (ISO). The relevant ISO standards specify the required data elements to be included on the tracks including, for example, the credit card holder's primary account number, a country code, the account holder's name, and a longitudinal redundancy check value. In addition to the foregoing specified data elements, the relevant ISO standards also reserve a data field for use at the discretion of the card issuer. This field is called the “discretionary data field.” Card issuers typically store an authentication value in the discretionary data field. On MasterCard cards, the CVC1 value is stored in the discretionary data field.

Unfortunately, the static nature of a conventional authentication value (whether printed on the surface of the card or stored in the magnetic stripe) increases the risk of fraud, because if an unauthorized person obtains the account information and the printed authentication value or the card's magnetic stripe data, that person has all the information required to fabricate a duplicate card.

One approach to reducing the risk of fraud is to use smart cards or integrated circuit cards, which include internal processing functionality, to produce dynamic authentication values. To date, however, smart card technology has used digital signature schemes based on public key cryptography techniques. Such an approach is costly and inconvenient because it requires cards and terminals that must perform cryptographic functions and requires the management of public keys. Furthermore, this approach requires the costly modification of and/or addition to the existing payment network infrastructure that currently exists, because the existing infrastructure has been designed for processing magnetic stripe payment cards.

A need therefore exists for better, more cost-effective security on payment cards than is currently available from conventional systems without the need for costly updates to existing systems.

### OBJECTS AND SUMMARY OF THE INVENTION

This invention addresses the above-described drawbacks of the prior art by using a dynamic authentication value—preferably generated cryptographically—which is placed in the discretionary data field of an ISO standard track (preferably, Track 1 and/or Track 2) data field by a proximity device or by a terminal, and is transmitted from the terminal to an issuer of the card. Along with the dynamic authentication value, the discretionary data field also includes other data to be used by an issuer for authentication purposes. Preferably, the dynamic authentication value is not the same as the static authentication printed on a magnetic stripe card, but instead, changes with each transaction. As a result, even if an unauthorized person obtains an authentication value for a particular transaction, the unauthorized person could not use that authentication value for other transactions. Furthermore, because the authentication data is stored or transmitted in an already-defined field of Track 1 and/or Track 2, no modifications to existing networks are needed.

In accordance with one aspect of the present invention, a transaction is conducted using a proximity device by the following steps: dynamically generating a first authentication value; transmitting the first authentication value from the proximity device to a terminal; including the first authentication value in a discretionary data field of message data, the message data being arranged in an ISO standard format; and transmitting the message data from the terminal to an issuer. Preferably, the message is arranged in an ISO Track 1 or ISO Track 2 format.

In accordance with an additional aspect of the present invention, a transaction is conducted using a proximity device by the following steps: generating a random number; transmitting an authentication command contactlessly from the terminal to the proximity device, the authentication command or subsequent message including the random number; dynamically generating first authentication value using a first authentication key by the proximity device to derive the first authentication value from data comprising at least the random number; transmitting the first authentication value from the proximity device to a terminal; including the first authentication value in a discretionary data field of message data, the message data being arranged in a format including at least one of an ISO Track 1 and an ISO Track 2 format; transmitting the message data from the terminal to an issuer; deriving a second authentication key by the issuer; calculating the second authentication value by the issuer using the second authentication key and the message data; and comparing the second authentication value to the first authentication value by the issuer.

In accordance with another aspect of the present invention, a transaction is conducted using a proximity device by the following steps: dynamically generating a first authentication value; transmitting the first authentication value and a card serial number or other identifier from the proximity device to a terminal; determining the card account number and/or expiry date associated with the card serial number or other identifier; including the first authentication value in a discretionary data field of message data, the account number in a primary account field of message data, and the expiry date in an expiry date field of message data, the message data being arranged in an ISO standard format; and transmitting the message data to an issuer. Preferably, the message is arranged in an ISO Track 1 or ISO Track 2 format.

The present invention provides better security than is currently available on conventional magnetic stripe payment cards and more cost-effective security than is currently available from conventional smart cards. In addition, the present invention utilizes the existing payment card infrastructure already in place and does not require significant hardware and software changes to that infrastructure.

### BRIEF DESCRIPTION OF THE DRAWINGS

Further objects, features, and advantages of the invention will become apparent from the following detailed description taken in conjunction with the accompanying figures showing illustrative embodiments of the invention.

FIG. 1 is a diagram of the interacting components of a system for conducting a transaction using a dynamic authorization value in a discretionary data field according to an exemplary embodiment of the present invention;

FIG. 2 is a diagram illustrating an exemplary layout of data arranged in a Track 1 format;

FIG. 3 is a diagram illustrating an exemplary layout of data arranged in a Track 2 format;

FIG. 4(a) is a diagram illustrating a layout of the additional data field of FIG. 2 in one exemplary embodiment of the present invention;

FIG. 4(b) is a diagram illustrating a layout of the additional data field of FIG. 3 in one exemplary embodiment of the present invention;

FIG. 5(a) is a diagram illustrating a layout of the discretionary data field of FIG. 4(a) in one exemplary embodiment of the present invention;

FIG. 5(b) is a diagram illustrating a layout of the discretionary data field of FIG. 4(b) in one exemplary embodiment of the present invention; and

FIG. 6 is a flow diagram illustrating a exemplary process whereby a transaction is conducted between a proximity device and an issuer.

While the subject invention will now be described in detail with reference to the figures, it is done so in connection with the illustrative embodiments. It is intended that changes and modifications can be made to the described embodiments without departing from the true scope and spirit of the subject invention as defined by the appended claims.

### DETAILED DESCRIPTION OF THE INVENTION

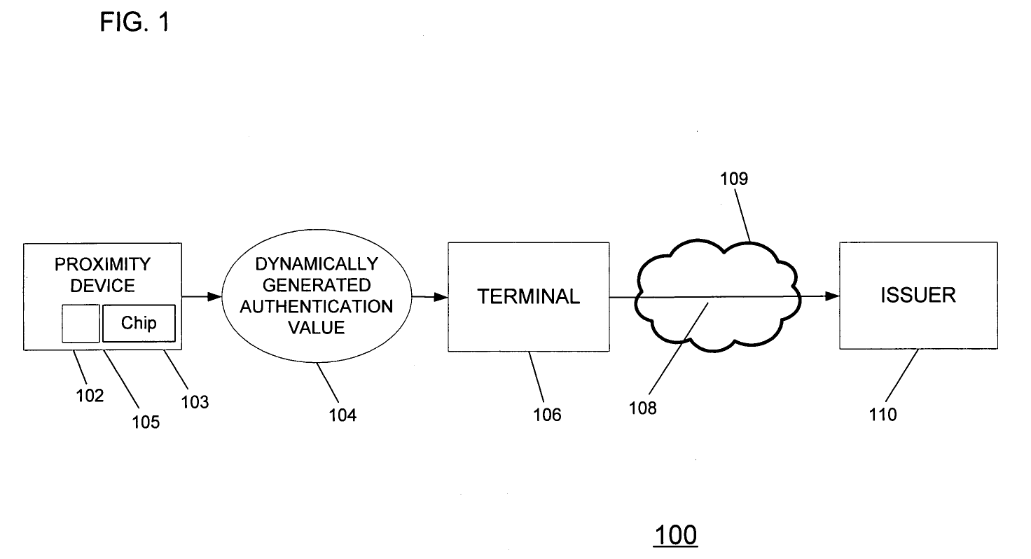

FIG. 1 depicts an exemplary system for conducting transactions according to the present invention. The illustrated system includes a proximity device 102 which can be in the form of a credit card and may include (but is not required to include) a magnetic stripe. The proximity device 102 can also take other forms, such as a key fob, a mobile phone, or a watch. The proximity device 102 transmits a dynamically generated authorization value 104 to a terminal 106. The authorization value is typically transmitted via an RF (radio frequency) signal. The authentication value is formatted in a discretionary data field 108 of Track 1 and/or Track 2 and transmitted to an issuer 110, typically through a computer network 109. The formatting can take place in either the proximity device 102 or in the terminal 106.

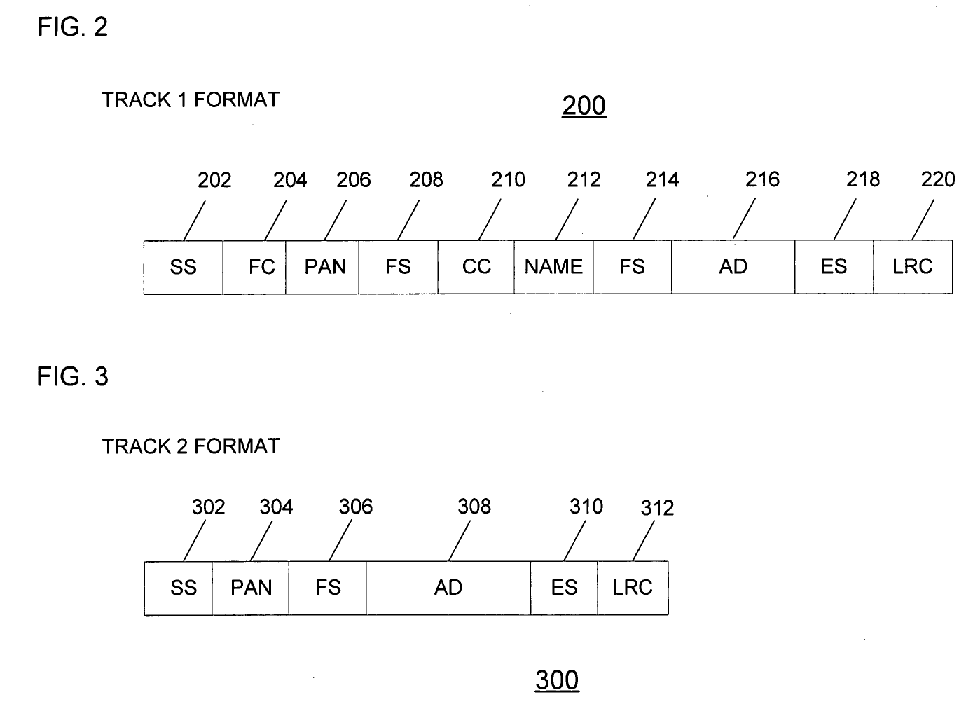

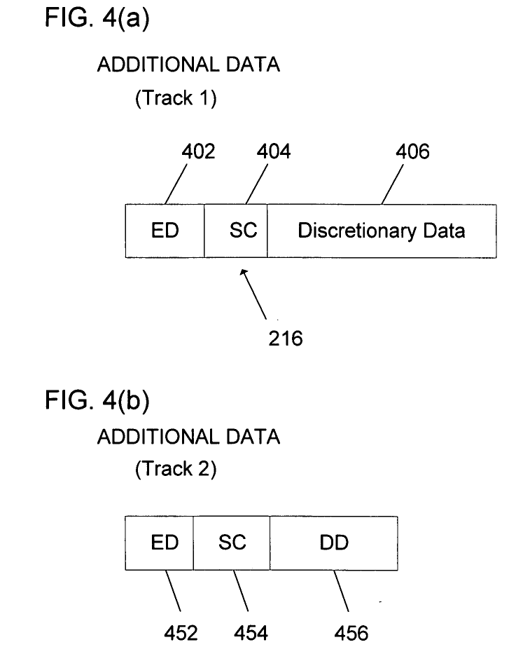

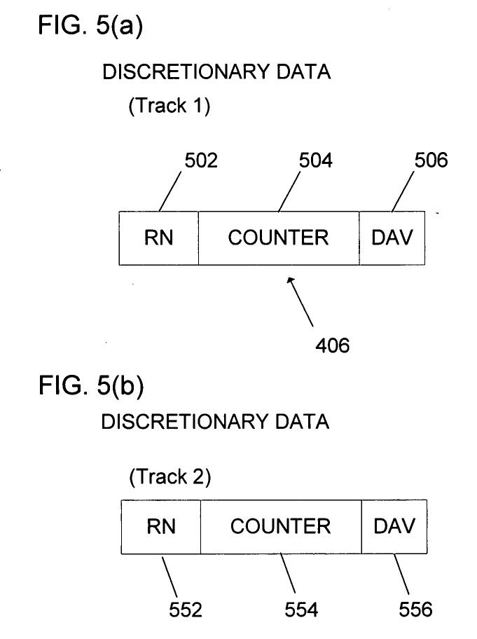

The layout of data arranged in an ISO Track 1 format is illustrated in FIG. 2. The Track 1 layout includes a start sentinel 202, followed by a format code 204, followed by a primary account number 206, followed by a field separator 208, followed by a country code 210, followed by the name of the account holder 212, followed by a field separator 214, followed by additional data 216, followed by an end sentinel 218, and finally by a longitudinal redundancy check 220. The additional data 216 can include an expiry date 402, a service code 404, and discretionary data 406, as depicted in FIG. 4(a). The discretionary data 406 can include a random number 502, a counter value 504, and a dynamic authorization value 506, as depicted in FIG. 5(a).

In addition to the dynamic authentication value, the proximity device may also store and transmit to the terminal the primary account number (PAN) and expiry date. Transmitting this information over a wireless communication channel, however, poses a risk of fraud in that a person may intercept the information and use it for unauthorized purposes. Accordingly, as an alternative, the proximity device may transmit a card serial number or other identifier to the terminal. The card serial number or other identifier may be associated with a PAN and an expiry date in one or more databases. The database(s) may be maintained by the card issuer or a service provider. Alternatively, the database(s) may be maintained by each merchant operating the terminals, although this has the disadvantage that the database(s) would not be centrally maintained. If a merchant has direct access to the database(s), once a merchant terminal receives the serial number or other identifier, it may search the database(s) for the associated PAN and expiry date and format a message to the issuer with this PAN and expiry date. If an issuer or service provider is maintaining the database(s), a terminal may communicate the serial number or other identifier to that issuer or service provider, who will determine the associated PAN and expiry date. The accountholder of the proximity device may only use the proximity device in merchant locations that have direct access to the database(s) and/or are in communication with parties who have access to the database(s). Either the merchant itself or the parties maintaining the database(s) may format a message in an ISO defined format for transmission to the issuer.

The layout of data arranged in a Track 2 format is illustrated in FIG. 3. The Track 2 layout includes a start sentinel 302, followed by a primary account number 304, followed by a field separator 306, followed by additional data 308, followed by an end sentinel 310, and finally by a longitudinal redundancy check 312. The additional data 308 may include an expiry date 452, a service code 454, and discretionary data 456, as depicted in FIG. 4(b). The discretionary data 456 can include a random number 552, a counter number 554, and a dynamic authorization value 556, as depicted in FIG. 5(b). The counter number 554 may be either all or only a portion of the digits of a counter.

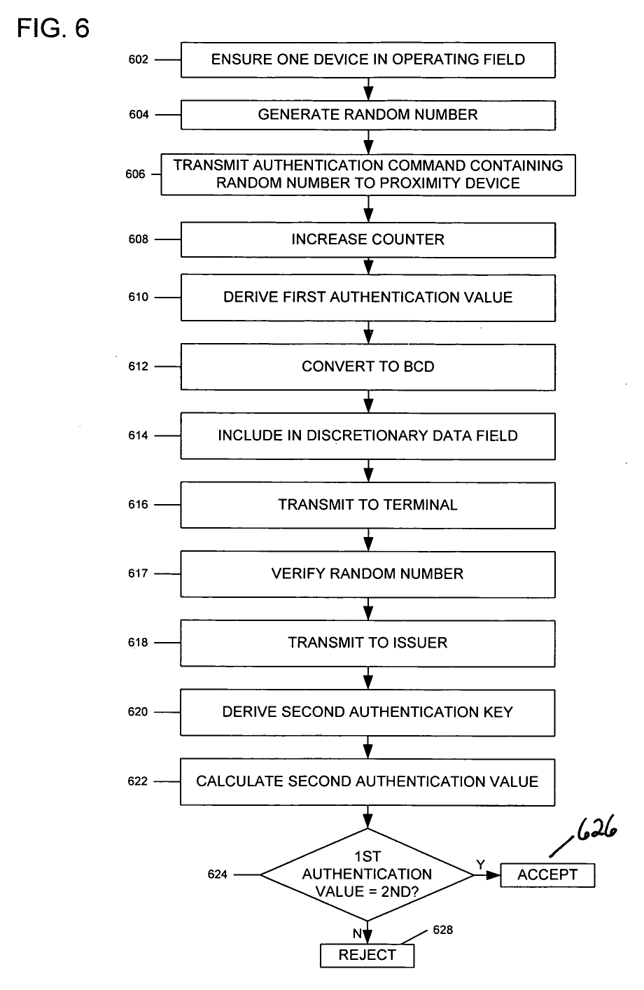

FIG. 6 illustrates an exemplary procedure for conducting a transaction using the system illustrated in FIG. 1. Optionally, the terminal 106 can check to ensure that only one proximity device 102 is within its operating field (step 602). In any case, the terminal 106 or the issuer 110 generates a random number (step 604). The random number can be generated, for example, by a conventional random number generation algorithm or by a hardwired random number generator, and can be in BCD, hexadecimal (HEX) or other format. Such random number generation algorithms and hardwired random number generators are well known in the art. The terminal 106 transmits an authentication command containing the random number to the proximity device 102 (step 606). Alternatively, the random number may be sent separately from the authentication command. The proximity device 102 contains a proximity chip, which maintains a counter and in an exemplary deployment increases the counter each time an authentication command is received (step 608). The frequency with which the counter is incremented and the increment value of the counter may vary. The counter can be in binary, BCD, HEX or other format. The proximity chip within the proximity device 102 derives a first authentication value using a first authentication key from the random number received (step 610). The authentication key can be stored, for example, in the memory of the proximity chip. The proximity device 102 includes the first authentication value in a set of message data—optionally, in the discretionary data field of Track 1 and/or Track 2 message data—(step 614) and transmits the message data contactlessly to the terminal 106 (step 616). The message data also includes the random number and a counter value maintained by the proximity chip, or representations thereof. Preferably, the random number or representation thereof in the message data is verified (step 617) at the terminal 106 by comparing it with the random number previously transmitted to the device 102. The representation of the random number can, for example, be only the final 3 digits of a longer number previously transmitted to the device. If the first authentication value was not formatted (in step 614) by the proximity device 102 as part of the discretionary data field of Track 1 and/or Track 2 message data, this formatting is performed by the terminal 106. In any case, the terminal 106 or the proximity device 102 converts remaining data into the appropriate format for either Track 1 or Track 2.

The terminal 106 transmits the data arranged in a Track 2 format 104 to the issuer 110 (step 618). The issuer 110 derives a second authentication key (step 620), presumably the same key as the first authentication key stored in the proximity device 102. The issuer 110 calculates a second authorization value using message data received from the proximity device via the terminal (step 622). The issuer 110 compares the first authentication value with the second authentication value (step 624) and either accepts (step 626) or rejects (step 628) the transaction depending on whether the values match.

The proximity device 102 preferably supports various features, such as an authentication key, a secure messaging key to write to memory areas that are protected, and a manufacturer cryptographic key. The manufacturer cryptographic key allows an issuer to securely load the authentication key, the secure messaging key, and payment related data. Single and double length cryptographic keys should be also supported. The proximity device 102 preferably protects against data written to the device memory against deletion or modification, and prohibits the external reading of memory locations containing a cryptographic key. The proximity device 102 should also maintain a counter, preferably of at least 15 bits, and should increase the counter (step 608) every time the authenticate command is presented (step 606) to the device 102. The device 102 can implement communication interface Type A or Type B, or both as specified in ISO/IEC 14443 parts 1-4, which are well known in the art, and are incorporated herein by reference.

Preferably, the terminal 106 is configured to be capable of reading a magnetic stripe card as well as a proximity device 102. For a device containing both a magnetic stripe and a proximity chip, the terminal 106 should first try to perform the transaction using the proximity chip reader, and should use the magnetic stripe if there is an error in communicating with the chip.

Preferably, two commands are used to send data from the terminal 106 to the proximity device 102, a select command and an authenticate command. The select command is used to select a proximity chip payment application. The authenticate command initiates computation of the dynamic authentication code within the proximity device. A third or more message pairs may be added to split the data into different message sets or to perform other optional functions. The response to the authenticate command from the device 102 can contain Track 2 formatted data, the device serial number, and transaction flags.

The preferred method of calculating the dynamic authentication value is the well known Data Encryption Standard (“DES”). The proximity device 102 preferably calculates the dynamic authentication by the following steps. First, a string of bits is constructed by concatenating, from left to right, the four rightmost bits of each character of the primary account number (up to 16×4=64 bits), the expiry date (4×4=16 bits), and the service code (3×4=12 bits). Also concatenated to the bit string are the device proximity chip counter (15 bits) and the 5-digit random number (5×4=20 bits) generated by the terminal 106. However, the order of the fields in the string may be varied. The bit string is padded with binary zeros to a multiple of 64 bits (typically, to a total of 128 bits). For example, the Track 2 “discretionary data” field 456 is 13 BCD when the primary account number is 16 BCD and the DES calculation of the discretionary data field 456 uses all 13 BCD. When the primary account number is less than 16 BCD, the issuer can increase the size of the dynamic authentication value field 556 in the discretionary data field 456 beyond 3 BCD digits. Next, an 8-byte MAC (Message Authentication Code) is calculated using the proximity chip secret authentication key (single or double length). The first 3 numeric digits (0-9) from left to right are extracted from the HEX result of the second step above. If less than 3 digits are found, characters A to F from left to right from the result of step 2 above are extracted and 10 is subtracted to compensate for decimals, until 3 digits are found. The first three digits found are used as the dynamic authentication value.

Preferably, the proximity chip converts the proximity chip counter (15-bit) to BCD using the following steps. First, the chip selects the leftmost 3 bits of the counter, adds a zero bit to the left, and converts the result to BCD. Next, the chip selects the next 3 bits of the counter, adds a zero bit to the left and converts the result to BCD. The chip performs the second step an additional 3 times to translate the 15 bit counter to 5 BCD characters. If the above described procedure is used for converting the counter to BCD, each BCD digit will range from 0 to 7. Alternately the counter in the proximity chip can itself be in BCD format, in which case the same format is preferably used in the issuer host system. A BCD-encoded counter makes it possible to increase the size of the maximum counter value to 99,999 in the chip using decimal counting (5 BCD characters, 4 bits per character using only BCD 0-9 characters), although this typically requires more processing logic in the chip.

The proximity device 102 replaces the discretionary data field 456 of Track 2 with the random number (5 BCD) field 552, the proximity chip counter (5 BCD) field 554, and the dynamic authentication value (3 or more BCD) field 556. The proximity device 102 returns the Track 2 data to the terminal 106 in the response to the authenticate command (step 616). The Track 2 data (maximum 19 ‘8 bit’ binary bytes) may be TLV (Tag Length Value) coded (Tag=“57”). The Track 2 data is assembled as follows, using 4-bit BCD values. A Start Sentinel is followed by the Primary Account Number (up to 16 BCD). This is followed by a Field Separator, which may be Hex. ‘D’. This is followed by an Expiration Date, which may be 4 BCD in the format of YYMM. This can be followed by a Service Code (3 BCD). This may be followed by the Dynamic Discretionary Data (13 or more BCD). The discretionary data can include the random number (5 BCD), followed by the proximity chip counter (5 BCD), followed by the Dynamic authentication value. The dynamic authentication value may be 3 BCD when account number is 16 digits, but it can be greater than 3 BCD if account number is less than 16 digits. The discretionary data may be followed by an End Sentinel and a Longitudinal Redundancy Check. Thus, while the discretionary data field used on a traditional magnetic stripe card merely contains enough characters to fill out the maximum record length of Track 2 (40 characters total) and is generally not verified during a transaction, the discretionary data field used with a proximity device in the illustrated example contains a dynamic authentication value in the discretionary data of Track 2 used for authentication of the device.

Some proximity chip manufacturers may not be able to produce a reduced functionality device that supports a DES algorithm. In such cases, a proprietary method can be used to calculate the device dynamic authentication value. Preferably, such a proprietary method should have the following features. A proven proprietary cryptographic algorithm should be used. The proximity chip counter should have a minimum of 15 bits and should be coded as BCD characters. The random number should be 5 digits (5 BCD). The primary account number, the Expiry Date, the Service Code, the proximity chip counter, and the random number should be included in the calculation of the dynamic authentication value. The dynamic authentication value should have a minimum of 3 BCD characters. The proximity device 102 should be able to replace the Track 2 discretionary data 306 with the random number, the proximity chip counter, and dynamic authentication value (minimum 3 BCD). The device 102 should return the whole Track 2 data, the proximity device serial number and proximity device transaction flags. The random number, the proximity device proximity chip counter, and proximity device generated dynamic authentication value should fit in the discretionary data field 456 of the Track 2 data sent to a terminal 106.

Each proximity chip authentication key is preferably unique and is preferably derived from a Master Derivation Key protected by the issuer. The Master Derivation Key should be a double length key. Derivation of proximity chip keys should preferably be done in a secure cryptographic device. An encryption function should use the primary account number and the master derivation key to derive the proximity chip authentication key. When a double length proximity chip authentication key is used, the second part of the key should be derived by complementing each bit of the primary account number (1 bits changed to 0, 0 bits changed to 1) before the encryption process.

Even if the issuer uses a proprietary authentication method, the key derivation process should still be similar to the method described above. The device authentication key preferably has a minimum of 48 bits (64 for DES). The bit size doubles for a double length device key.

Upon receipt of an authorization request, the issuer performs the following steps. The issuer determines if the request originates from a proximity device 102, in order to initiate processing specific to proximity devices. For example, the issuer can do this by a decoding data element (61 position 10) which the terminal would set to a value of ‘7’ to indicate that the request originated from a proximity device that the terminal read. Alternately, or in addition, the issuer can list into the cardholder database the Primary Account Numbers assigned to the proximity device 102. The issuer host system should, for each proximity device 102, keep track of the proximity chip counter and verify that the proximity chip counter received is the next sequential number. Verification of the proximity chip counter can be used to prevent transaction replay. Repeated counter values can also indicate the capture of proximity chip Track 2 data. The issuer derives the proximity chip authentication key as specified above. The issuer calculates the proximity device Dynamic authentication value as described above using the primary account number, Expiry Date, Service Code from the received Track 2, and the authentication data (proximity chip counter, random number) in the Track 2 discretionary field. The issuer compares the calculated Dynamic authentication value to the one in the proximity device Track 2 discretionary data field. The issuer can process the authorization as a magnetic stripe authorization when the dynamic authentication value is successfully verified.

Derivation of proximity chip keys and verification of the dynamic authentication value should preferably be done in a secure cryptographic device, such as a host security module.

While there have been described what are believed to be the preferred embodiments of the present invention, those skilled in the art will recognize that other and further changes and modifications may be made thereto without departing from the spirit of the invention, and it is intended to claim all such changes and modifications as fall within the true scope of the invention. For example, specific calculations for the dynamic authentication value have been shown for an embodiment with a Track 2 layout but the invention is also applicable to a Track 1 layout.

1. A method of conducting a transaction with a payment account having an associated account number and using a proximity device, comprising:
associating an identifier with said account number;
dynamically generating a first authentication value;
transmitting not the payment account number but the first authentication value and said identifier from the proximity device;
including the first authentication value in a discretionary data field of message data, the message being arranged in an ISO format; and
transmitting the message data including said identifier for verification.

2. The method of claim 1, further comprising:
storing said identifier in a database maintained by an issuer of said payment account;
transmitting said identifier to said issuer; and
determining at said issuer the associated account number.

3. The method of claim 1, further comprising:
storing said identifier in a database maintained at a terminal;
transmitting the first authentication value and said identifier from the proximity device to said terminal;
determining at said terminal the associated account number; and
transmitting said message data including the determined associated account number for verification.

4. The method of claim 3, wherein the message data includes a primary account field, and said determined associated account number is included in said account field.

5. The method of claim 1, wherein said identifier is further associated with an expiry date.

6. The method of claim 1, wherein said identifier is a card serial number.

7. A system for conducting a transaction with a payment account having an associated account number and using a proximity device, comprising a processing arrangement configured to perform the steps of:
associating an identifier with said account number;
dynamically generating a first authentication value;
transmitting not the payment account number but the first authentication value and said identifier from the proximity device;
including the first authentication value in a discretionary data field of message data, the message data being arranged in an ISO format; and
transmitting the message data including said identifier for verification.

8. The system of claim 7, further comprising:
storing said identifier in a database maintained by an issuer of said payment account;
transmitting said identifier to said issuer; and
determining at said issuer the associated account number.

9. The system of claim 7, further comprising:
storing said identifier in a database maintained at a terminal;
transmitting the first authentication value and said identifier from the proximity device to said terminal;
determining at said terminal the associated account number; and
transmitting said message data including the determined associated account number for verification.

10. The system of claim 9, wherein the message data includes a primary account field, and said determined associated account number is included in said account field.

11. The system of claim 7, wherein said identifier is further associated with an expiry date.

12. The system of claim 7, wherein said identifier is a card serial number.
